(19) United States
(12) Patent Application Publication
(10) Pub. No.: US 2003/0230577 A1
(43) Pub. Date: Dec. 18, 2003

(54) Method for inhibiting the leakage of containers during shipping and containers formed therefrom

(75) Inventor: C. Kelly Smith, Simpsonville, SC (US)

Correspondence Address: DORITY & MANNING, P.A., POST OFFICE BOX 1449, GREENVILLE, SC, 29602-1449, US

(73) Assignee: PrintSource Incorporated

(21) Appl. No.: 10/174,519

(22) Filed: Jun. 18, 2002

(51) Int. Cl. G09F 3/00; B65D 45/00

(52) U.S. Cl. 220/315; 206/459.5; 40/310; 40/311

(57) ABSTRACT

A method for inhibiting the leakage of a container during handling or shipping is provided. The container can have a body that defines a base portion and a top portion to which a lid is removably secured. A sealing label is adhesively attached to the lid and container body to inhibit the loosening of the lid. For example, in one embodiment, the sealing label includes a polyolefin film facestock and a rubber-based adhesive that is solvent-resistant.

### BACKGROUND OF THE INVENTION

While some products are sealed with various types of tamper-resistant sealants during packaging, many other products do not require such expensive packaging methods. For example, many common household products and medical supplies, such as liquid detergents, ammonia, vinegar, hydrogen peroxide, rubbing alcohol, bleach and the like, can be packaged and shipped in bottles that are capped merely with screw-top lids, not requiring “under-the-cap” seals or other known types of tamper-resistant packaging. During shipping to distributors and/or consumers, these “screw-top lid” containers are generally subjected to vibration, shifting, sudden jolts and shocks, and even inversion. Even when not excessively rough, typical handling can cause the screw-top lids to become loose, causing some or all of the contents of the container to spill.

Unfortunately, spillage of the product during shipping and handling can cause a variety of problems. For example, the contents of the container can spill onto the surface of other containers within the carton, causing the containers to become unsightly and require cleaning prior to delivery or sale. In addition, the spilled contents can damage or destroy labels on the containers. Moreover, containers often contain corrosive liquids (e.g., hydrogen peroxide, ammonia, rubbing alcohol, bleach, and the like) that can be hazardous to the surrounding environment and also cause damage to certain materials when spilled. In addition, spillage also results in loss of the product, which is clearly undesired.

As such, a need currently exists for an inexpensive and efficient method to preventing leakage and spillage of a product during normal shipping and handling operations.

### SUMMARY OF THE INVENTION

In accordance with one embodiment of the present invention, a container having contents (e.g., liquid detergents, ammonia, vinegar, hydrogen peroxide, rubbing alcohol, bleach, and the like) substantially inhibited from leaking during handling and shipping is disclosed. The container includes a body having a base portion and a top portion, wherein the top portion defines an opening through which a fluid is capable of flowing. Optionally, the body has a neck portion spaced between the top portion and the base portion. The container also includes a lid removably secured to the top portion of the container body.

In addition, the container includes a sealing label that comprises a facestock and an adhesive applied to a surface of the facestock, the adhesive being generally solvent-resistant. The sealing label is adhesively attached to the container body and the lid to substantially inhibit the removal of the lid from the top portion. For example, the sealing label can be attached to the top portion and/or the neck portion of the container body. In some embodiments, the sealing label has a first end and a second end that are adhesively attached to the container body. Moreover, the sealing label can also have a middle section spaced between the first end and the second end, wherein the middle section is adhesively attached to the lid. Further, in other embodiments, the sealing label can be wrapped around at least a portion of the lid and container body.

In accordance with another embodiment of the present invention, a method for inhibiting the leakage of the contents of a container during handling and shipping is disclosed. The method includes providing a container having certain contents. The container comprises a body having a base portion and a top portion, the top portion defining an opening through which a fluid is capable of flowing. The container further comprises a lid removably secured to the top portion of the container body. A sealing label is provided that comprises a facestock and an adhesive applied to a surface of the facestock, the adhesive being generally solvent-resistant. The adhesive-coated surface of the sealing label is adhesively attached to the lid and the container body, wherein the adhesive attachment substantially inhibits the removal of the lid from the top portion.

Other features and aspects of the present invention are described in greater detail below.

### BRIEF DESCRIPTION OF THE FIGURES

A full and enabling disclosure of the present invention, including the best mode thereof, directed to one of ordinary skill in the art, is set forth more particularly in the remainder of the specification, which makes reference to the appended figures in which:

FIG. 1 illustrates one manner in which a container of the present invention can be utilized;

FIG. 2 illustrates one embodiment of a container that can be used in the present invention;

FIG. 3 illustrates one embodiment of a container applied with a sealing label in accordance with the present invention invention;

FIG. 4 illustrates another embodiment of a container applied with a sealing label in accordance with the present invention; and

FIG. 5 shows various embodiments of sealing labels that can be used in the present invention.

Repeat use of references characters in the present specification and drawings is intended to represent same or analogous features or elements of the invention.

### DETAILED DESCRIPTION OF REPRESENTATIVE EMBODIMENTS

It is to be understood by one of ordinary skill in the art that the present discussion is a description of exemplary embodiments only, and is not intended as limiting the broader aspects of the present invention which broader aspects are embodied in the exemplary construction.

In general, the present invention is directed to a method and system for preventing leakage and spillage of a liquid from a container during shipment. A lid is secured to the body of the container. Further, to inhibit spilling of liquid from the container during shipment, a sealing label is attached to the lid and to the body of the container. In one embodiment, for instance, the sealing label includes a generally solvent-resistant adhesive.

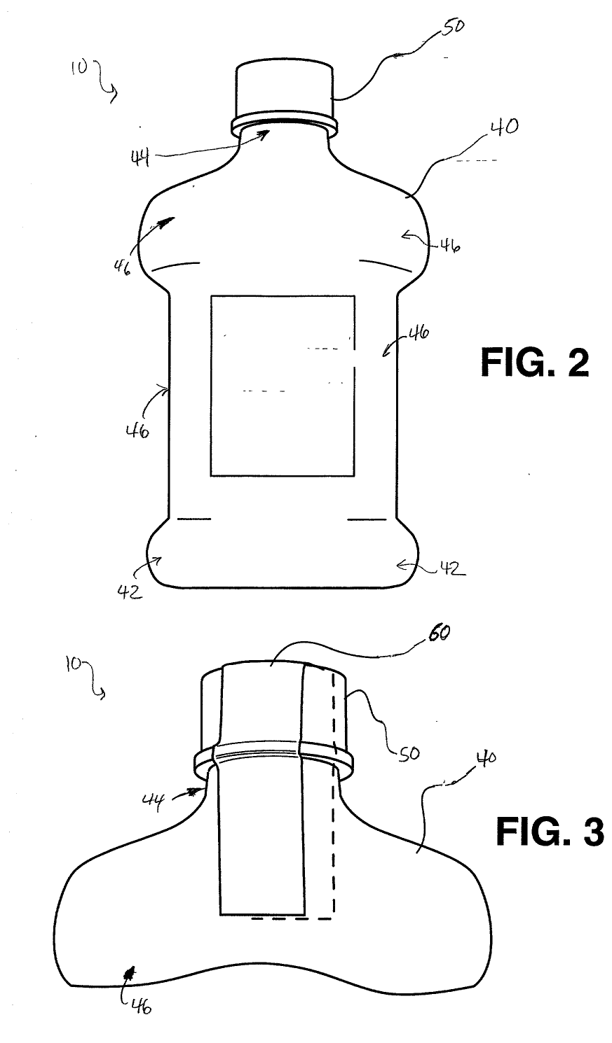

Referring to FIG. 2, for example, one embodiment of a container 10 that can be used in the present invention is shown. In this embodiment, the container 10 includes a body 40 having a base portion 42 and a top portion 44. An optional neck portion 46 is also spaced between the base portion 42 and the top portion 44. It should be understood that the container 10 depicted and described herein is but one embodiment of the present invention, and that other container configurations are also contemplated. For instance, the container 10 may generally have any size and/or shape, such as round, square, oval, rectangular, etc., and can hold any amount of the product. In some embodiments, for example, the container 10 can hold less than about five gallons of a product, in some embodiments less than about 1 gallon of a product, and in some embodiments, less than about 32 fluid ounces. The container 10 can also be formed of any suitable materials. For example, the container 10 can be formed of glass, metals, plastics, and the like. Additionally, various coatings, such as paint or ink images, can be formed on the container 10 or on an information label placed on a surface of the container 10.

A lid 50, such as a screw-top lid, is also removably secured to the top portion 44 of the container 10. For example, in one embodiment, the top portion 44 can contain threads (not shown) for threadably engaging the lid 50. The lid 50 can generally have any shape and/or size, and can be made from any of a variety of different materials, such as metals, plastics, glass, and the like.

To inhibit the spilling or leaking of a product contained with the container 10, a sealing label can be attached thereto. The sealing label can generally be attached to the container 10 in a variety of different ways. For example, referring to FIG. 3, one embodiment for attaching a sealing label 60 to the container 10 is illustrated. As shown, the sealing label 60 has a middle section 61 spaced between a first end 63 and a second end 65. If desired, the middle section 61 may be adhesively attached to the lid 50, while the first and second ends 63 and 65 may be adhesively attached to the container body 40 through one or more of the base portion 42, the top portion 44, and the neck portion 46. For example, in the illustrated embodiment, the first and second ends 63 and 65 are adhered to both the neck portion 46 and the top portion 44. When adhered to the container body 40, the sealing label 60 can, in some embodiments, extend less than about 3 inches below the base of the lid 50.

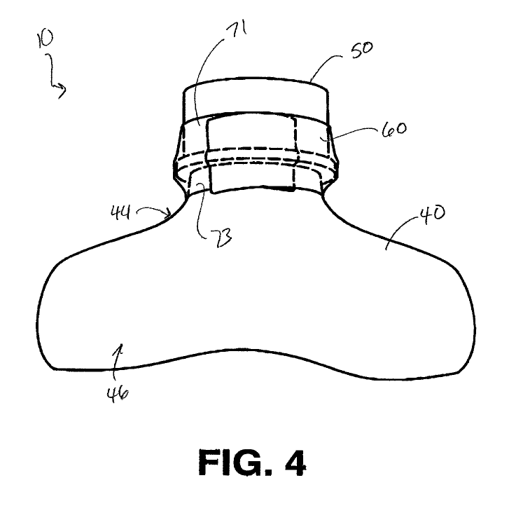

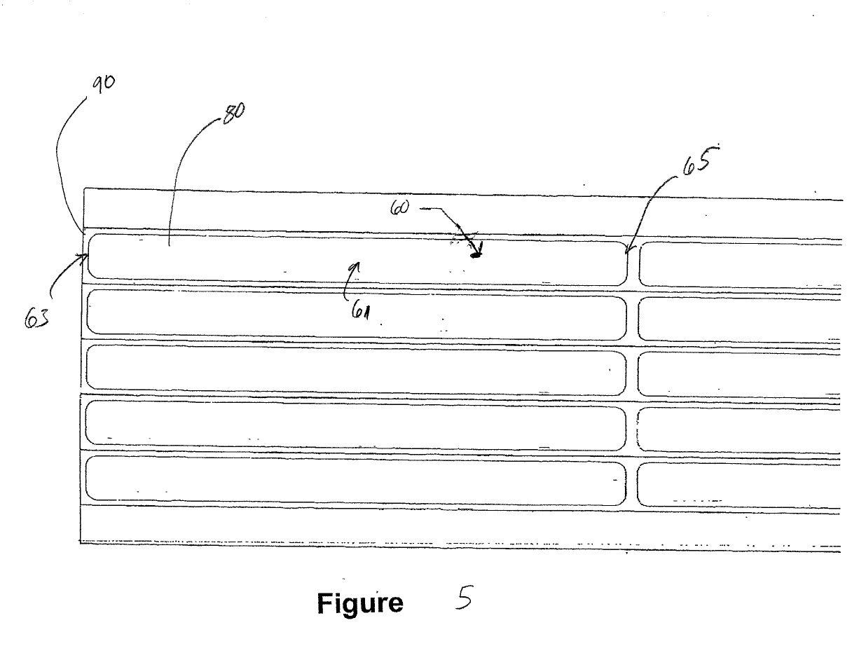

Moreover, referring to FIG. 4, another embodiment for attaching the sealing label 60 to the container 10 is illustrated. As shown, the sealing label 60 can be secured to the lid 50 and the body 40 of the container 10. Specifically, the sealing label 60 is wrapped around the lid 50 so that a upper section 71 of the sealing label is adhered to the lid 50 and a lower section 73 is adhered to the container body through one or more of the base portion 42, the top portion 44, and the neck portion 46. For example, in the illustrated embodiment, the upper section 71 extends the entirety or substantially the entirety of the outer perimeter of the lid 50, while the lower section 73 extends the entirety or substantially the entirety of the outer perimeter of the top portion 44. The sealing label 60, when applied in a manner such as described above, may or may not overlap.

The sealing label 60 can generally have any shape and/or size so that it can be placed on or around the lid 50 of the container 10 and adhesively attached to both the container body 40 and the lid 50 to substantially inhibit movement of the lid 50 in relation to the container body 40. For example, the sealing label 60 can have a rectangular shape and can be less than about 10 inches in length, and in some embodiments, less than about 7 inches in length. In addition, the sealing label 60 can be less than about 1 inch in width, and in some embodiments, less than about 0.75 inches in width. In one particular embodiment, the sealing label 60 can be about 6 inches in width and about 0.5 inches in length.

In addition, the sealing label 60 can be constructed with one or more layers as is well known in the art. For example, referring to FIG. 5, one embodiment of the sealing label 60 includes a facestock 80 and an adhesive (not shown) applied to a surface of the facestock 80. As shown, several labels 60 can be cut out from one section of a facestock 80 as in a sheet or roll of labels. The facestock 80 is generally thin enough to be easily and economically formed and manipulated and can have a high tear resistance. For example, the facestock 80 can have a caliper of less than about 10 mils, and in some embodiments, less than about 5 mils. Some examples of suitable facestock materials are described in U.S. Pat. No. 5,262,216 to Popat, et al.; U.S. Pat. No. 5,742,192 to Hughen, et al.; and U.S. Pat. No. 6,376,058 to Schut, et al., which are incorporated herein in their entirety by reference thereto for all purposes.

The facestock 80 is generally formed of a material that will not tear or rip easily and that can withstand encounters with liquids so that it will not easily deteriorate or be torn so as to break the attachment between the body 40 and the lid 50. If desired, the facestock 80 can also be able to accept an image, such as a printed or transfer image, and can optionally include a company logo or other print-type information on its surface. In one embodiment, the facestock 80 can be a polyolefin film. For example, the facestock 80 can be a polyethylene or a polypropylene polymer or copolymer film. Moreover, the facestock 80 can be a polyester film, such as Mylar® (sold by Du Pont), American Hoechst 3000 grade polyester film, and the like. In one particular embodiment, the facestock 80 can be Fasson® Battery Label Olefin, produced by the Avery Dennison Corporation.

As indicated above, the sealing label 60 also includes an adhesive applied to a surface of the facestock 80. The adhesive can generally be one that can form a strong, secure attachment between the body 40 and/or lid 50 and the facestock 80. In some applications, the adhesive may be a pressure sensitive adhesive, a heat-activated adhesive, or a hot-melt adhesive, such as used in in-mold label applications. It is generally desired that the adhesive remain functional for an expected period of time and after that period of time, retain the ability to be cleanly removed from the container 10 without leaving an adhesive residue. Removal typically occurs with destruction of the facestock 80 where it is no longer reusable. Accordingly, suitable adhesives are typically regarded more as “permanent” than as “removable.” Moreover, the adhesive can also be a generally solvent-resistant adhesive to inhibit degradation thereof when exposed to various contaminants. Such adhesives are generally well known in the art. In one embodiment, for example, the adhesive is a generally solvent-resistant, rubber-based permanent adhesive, such as, for example, Fasson® 1406 made by the Avery Dennison Corporation.

The sealing label 60 can be positioned on a liner 90 until ready for application to the container 10. Suitable liners are generally known in the art and can include, for example, supercalendered papers having a basis weight of from about 40 and about 60 pounds per ream. The liner 90 can hold one or more sealing labels 60 until application thereof to the container 10 prior to container shipment. For example the liner 90 can hold several labels 60 on a sheet or in a roll of labels.

Prior to shipping the container 10, a sealing label 60 can simply be peeled from the liner 90 and affixed to the container 10. For example, the sealing label 60 can be applied to the container either by the manufacturer, prior to shipment, or alternatively, by the shipping company, after receiving the container from the manufacturer and prior to shipment. In one embodiment, the sealing label 60 can also be used by individual purchasers of products. For example when shipping or transporting liquid goods, such as during travel or household moves, an individual consumer can seal containers holding cleaning supplies, shampoo, cooking supplies, and the like, even when the container has been previously opened and some of the contents used.

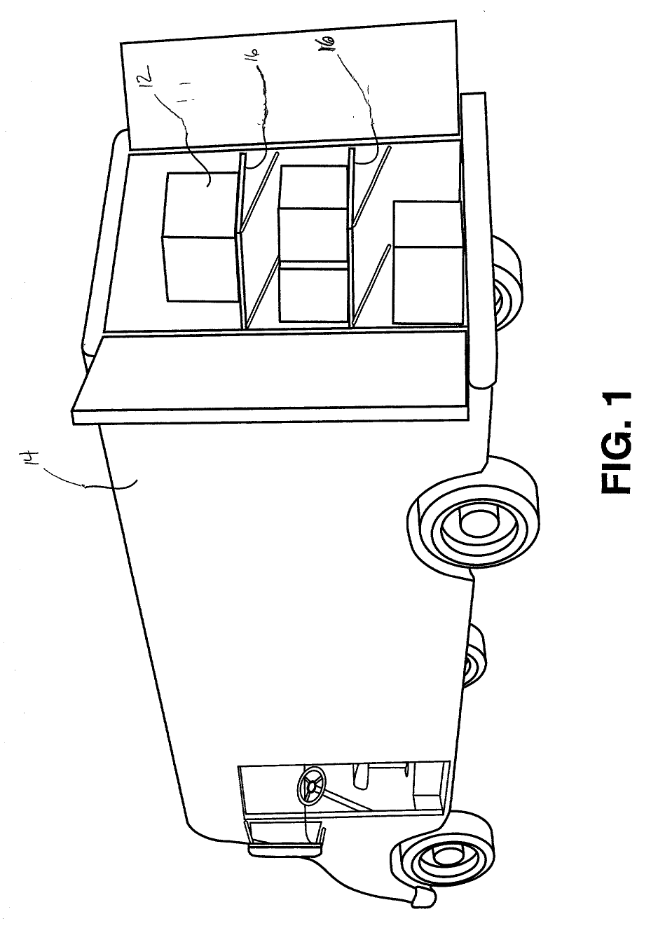

It has been discovered that a container sealed according to the present invention can be substantially inhibited from leaking or spilling during handling and shipment. For instance, after the bottling and capping process of a container, several containers 10 can be packaged together for shipping. When shipping and delivering products in containers, such as illustrated in FIG. 1, the containers can be packed together in a box or crate 12. The box 12 can then be loaded onto a truck 14 for transport and delivery. If desired, the shipping truck 14 can be lined on the interior with shelves 16 for storing boxes and packages during shipment. During shipping, the containers 10 can be subjected to vibrations and shifting as well as sudden shocks. Such standard occurrences often cause the lid 50 (FIGS. 2-3) to shake or otherwise come loose from the containers 10. This can lead to leakage or even spillage of the liquid contents of the container 10. However, as a result of the present invention, the lid 50 is substantially inhibited from loosening during handling and shipment. Specifically, the sealing label 60, when secured to the lid 60 and the body 40 of the container 10, limits rotational movement of the lid 50, and thus, inhibits it from loosening. In addition, because the adhesive of the sealing label 60 can be generally solvent-resistant, exposure to corrosive liquids, etc., will not generally deteriorate the ability of the sealing label 60 to continue to prevent leakage of the liquids from the container 10.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed is:

1. A container having contents that are substantially inhibited from leaking during handling and shipping, said container comprising:
a body having a base portion and a top portion, said top portion defining an opening through which a fluid is capable of flowing;
a lid removably secured to said top portion of said container body; and
a sealing label that comprises a facestock and an adhesive applied to a surface of said facestock, said adhesive being generally solvent-resistant, wherein said adhesive attachment substantially inhibits the removal of said lid from said top portion.

2. A container as defined in claim 1, wherein said container further comprises a neck portion spaced between said top portion and said base portion.

3. A container as defined in claim 2, wherein said sealing label is adhesively attached to said neck portion.

4. A container as defined in claim 1, wherein said sealing label is adhesively attached to said top portion.

5. A container as defined in claim 1, wherein said container has a volume of less than about 5 gallons.

6. A container as defined in claim 1, wherein said container has a volume of less than about 1 gallon.

7. A container as defined in claim 1, wherein the contents of said container include a corrosive liquid.

8. A container as defined in claim 7, wherein said liquid is rubbing alcohol.

9. A container as defined in claim 1, wherein said container is made from plastic.

10. A container as defined in claim 1, wherein said sealing label has a first end and a second end, said first end and said second end of said sealing label being adhesively attached to said container body.

11. A container as defined in claim 10, wherein said sealing label has a middle section spaced between said first end and said second end, said middle section being adhesively attached to said lid.

12. A container as defined in claim 1, wherein said sealing label is wrapped around at least a portion of said lid and said container body.

13. A container as defined in claim 1, wherein said adhesive is a rubber based permanent adhesive.

14. A container as defined in claim 1, wherein said facestock is a polyolefin film.

15. A method for inhibiting the leakage of the contents of a container during handling and shipping, said method comprising:
providing a container having certain contents, wherein said container comprises a body having a base portion and a top portion, said top portion defining an opening through which a fluid is capable of flowing, said container further comprising a lid removably secured to said top portion of said container body;
providing a sealing label comprising a facestock and an adhesive applied to a surface of said facestock, said adhesive being generally solvent-resistant; and
adhesively attaching the adhesive-coated surface of said sealing label to said lid and said container body, wherein said adhesive attachment substantially inhibits the removal of said lid from said top portion.

16. A method as defined in claim 15, wherein said container further comprises a neck portion spaced between said top portion and said base portion.

17. A method as defined in claim 16, wherein said sealing label is adhesively attached to said top portion.

18. A method as defined in claim 15, wherein said sealing label is wrapped around at least a portion of said lid and said container body.

19. A method as defined in claim 15, wherein the contents of said container include a corrosive liquid.

20. A method for inhibiting the leakage of the contents of a container during handling and shipping, said method comprising:
providing a container having certain contents, wherein said container comprises a body having a base portion and a top portion, said top portion defining an opening through which a fluid is capable of flowing, said container further comprising a lid removably secured to said top portion of said container body;
providing a sealing label comprising a facestock and an adhesive applied to a surface of said facestock, said adhesive being generally solvent-resistant;
adhesively attaching the adhesive-coated surface of said sealing label to said lid and said container body; and
thereafter, transporting the container, wherein said adhesive attachment substantially inhibits the removal of said lid from said top portion during transportation.
